(19) United States
(12) Patent Application Publication
(10) Pub. No.: US 2014/0224215 A1
(43) Pub. Date: Aug. 14, 2014

(54) FUEL FILTRATION SYSTEM

(71) Applicants: Martin A. Lehman, Congerville, IL (US); Eric J. Herron, Chillicothe, IL (US); Steven Y. Tian, Bloomigton, IL (US); Krishna K. Chinta, Grand Rapids, MI (US); Scott F. Shafer, Morton, IL (US); Byron R. Wear, Bloomington, IL (US)

(72) Inventors: Martin A. Lehman, Congerville, IL (US); Eric J. Herron, Chillicothe, IL (US); Steven Y. Tian, Bloomigton, IL (US); Krishna K. Chinta, Grand Rapids, MI (US); Scott F. Shafer, Morton, IL (US); Byron R. Wear, Bloomington, IL (US)

(21) Appl. No.: 13/762,755

(22) Filed: Feb. 8, 2013

(51) Int. Cl. F02M 37/22

(52) U.S. Cl. CPC F02M 37/22
USPC 123/446; 210/196; 210/136; 210/805; 210/195.1

(57) ABSTRACT

A fuel filtration system is provided. The fuel filtration system includes a pump configured to receive a flow of fuel from a fuel storage tank and at least one filter positioned downstream to the fuel filtration system and fluidly coupled to the pump. The fuel filtration system further comprises a recirculation loop configured to recirculate at least a portion of the fuel through the at least one filter. The recirculation loop is also configured to provide a remaining portion of the fuel to an engine during the recirculation. The remaining portion of the fuel is determined based on a fuel consumption of the engine.

### TECHNICAL FIELD

The present disclosure relates generally to a fuel filtration system of an engine, and more particularly to a re-circulation loop associated with the fuel filtration system.

### BACKGROUND

Contamination of fuel supplies for engines can result in damage to both fuel injection system components and engine components. For example, abrasive particles, which may cause wear and potential leakage, can adversely affect performance of the fuel injection and engine components and reduce the long-term durability of the components. With respect to diesel fuel, excessive water in the fuel supply may cause rusting of certain system components and may negatively impact moving components, particularly during freezing conditions. Common rail fuel systems which use precision valves exposed to high rail pressure to control operation of the fuel injectors may be particularly susceptible to damage caused by debris in the fuel supply. One or more fuel filters are typically positioned along a line supplying fuel from a fuel supply or tank to an engine in order to filter out or capture debris and/or water. However, these filters may capture only a portion of the contaminants. Further, fuel cleanliness standards in different parts of the system may vary greatly.

For example, U.S. Published Application No. 2012/0042855 discloses a low power marine fuel polishing system. The fuel polishing system utilizes a low power piezoelectric pump to circulate fuel from a fuel tank, through a filter, and then back to the fuel tank. The fuel polishing system is provided for a diesel fuel powered engine for a boat and is powered by a battery that is recharged by a solar energy panel. The fuel polishing system offers a low power onboard alternative to high power fuel polishing systems utilizing a high power consumption pump, which requires that the boat be hooked up to power at a dock.

### SUMMARY OF THE DISCLOSURE

In one aspect of the present disclosure, a fuel filtration system is provided. The fuel filtration system comprises a pump configured to receive fuel from a fuel storage tank, at least one filter positioned downstream of the fuel storage tank and fluidly coupled to the pump, and a recirculation loop provided across the pump and the at least one filter. The recirculation loop is configured to recirculate at least a portion of the fuel through the at least the at least one filter. Further, the recirculation loop is configured to provide a remaining portion of the fuel to an engine during the recirculation, wherein the remaining portion of the fuel is determined based on a fuel consumption of the engine.

In another aspect, a method for filtering fuel is provided. The method receives a flow of fuel directed towards a pump from a fuel storage tank. The method circulates the flow of fuel through at least one filter fluidly coupled to the pump. Further, the method recirculates at least a portion of the flow of fuel through the at least one filter. Also, the method provides a remaining portion of the flow of fuel to an engine during the recirculation. The remaining portion of the fuel is determined based on a fuel consumption of the engine.

Other features and aspects of this disclosure will be apparent from the following description and the accompanying drawings.

### BRIEF DESCRIPTION OF THE DRAWINGS

FIG. 1 illustrates an exemplary machine, according to one embodiment of the present disclosure;

FIG. 2 illustrates an exemplary configuration of a fuel filtration system present on the machine shown in FIG. 1;

FIG. 3 illustrates another exemplary configuration of the fuel filtration system; and

FIG. 4 illustrates a method for fuel filtration.

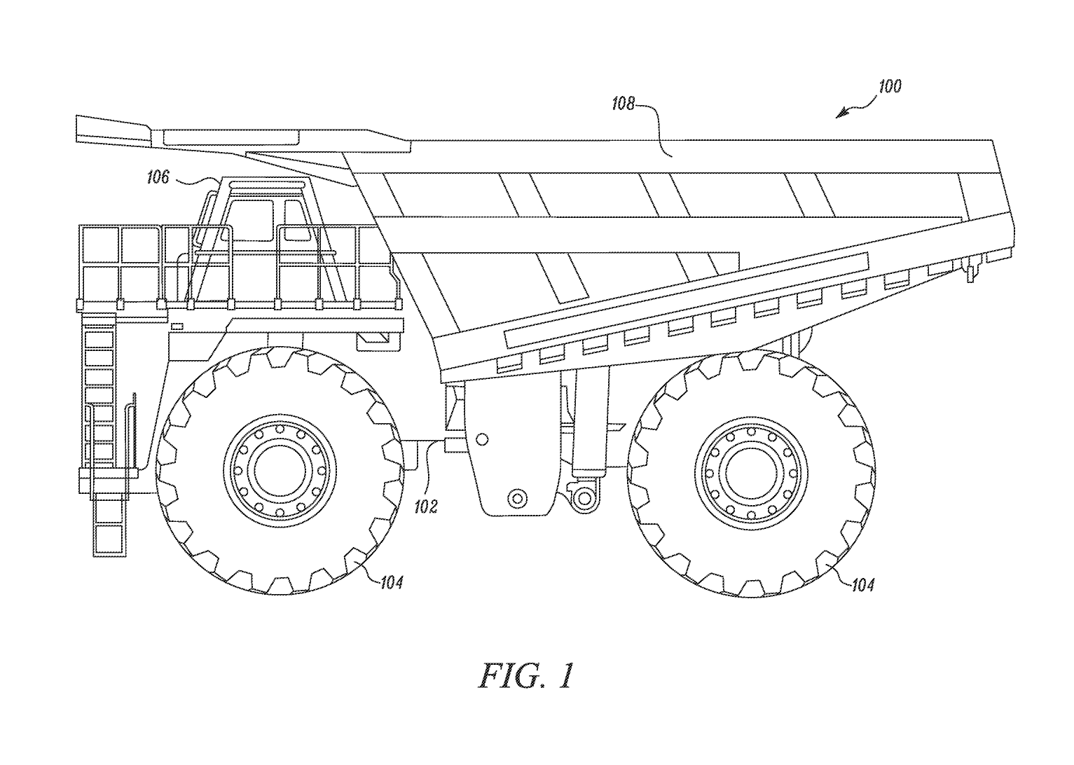

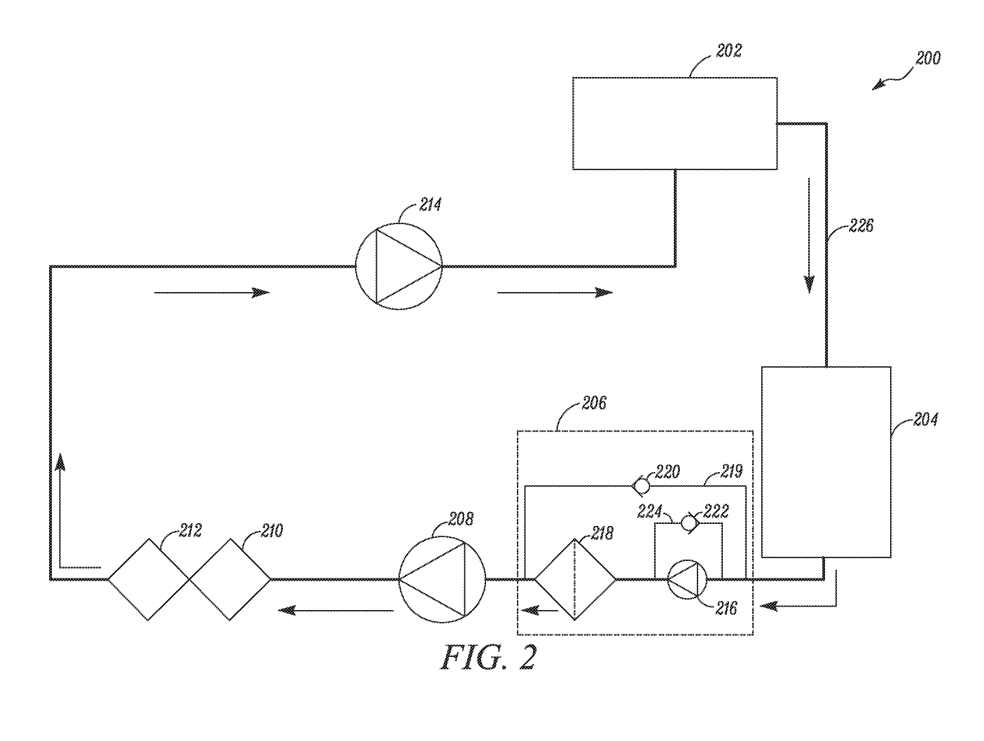

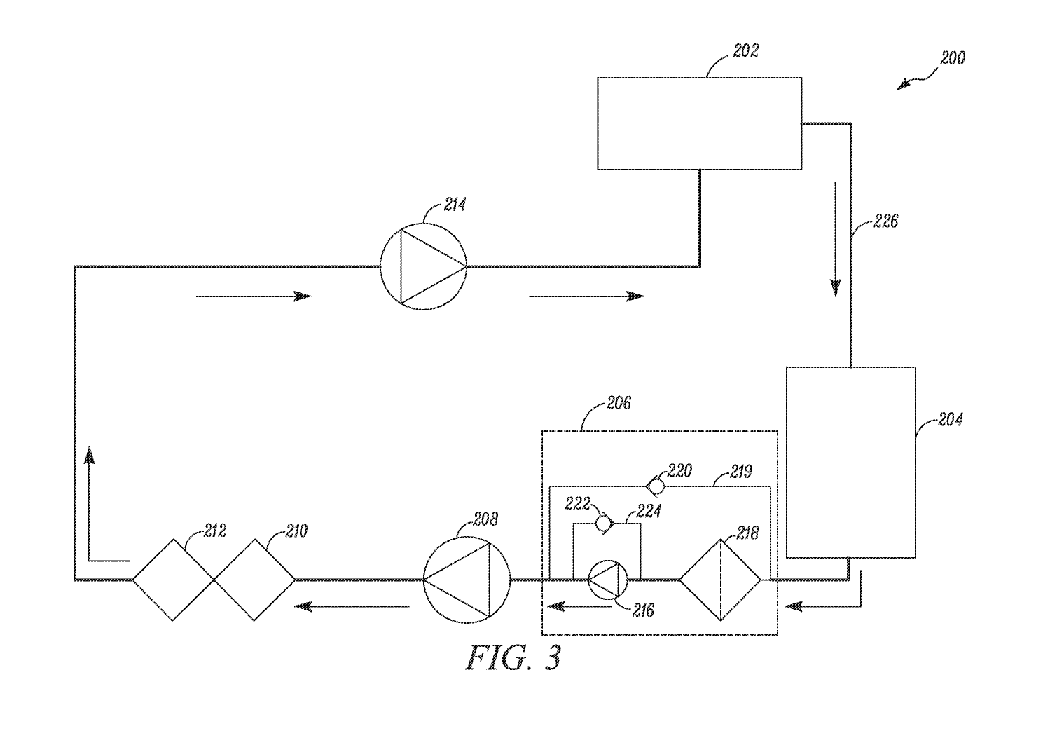

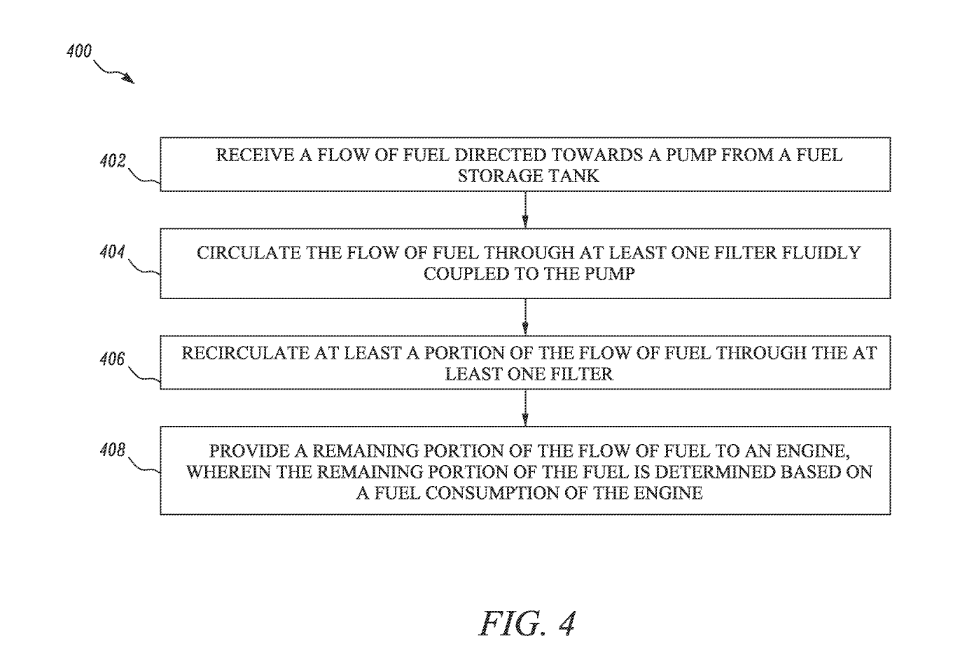

### DETAILED DESCRIPTION

Wherever possible, the same reference numbers will be used throughout the drawings to refer to the same or the like parts. An exemplary embodiment of a machine 100, according to the present disclosure is shown in FIG. 1. The machine 100 may be a mining truck, as shown, or may include any off-highway or on-highway vehicle using a fuel-powered engine, as described herein. The machine 100 generally includes a machine frame 102 for supporting, among other systems and components, an engine and fuel system which will be discussed in greater detail in connection with FIGS. 2 and 3.

The machine 100 also includes a plurality of ground-engaging elements 104, in this case being wheels. As should be appreciated by one of ordinary skill in the art, an engine of the engine and fuel system may provide propulsion power for the ground-engaging elements 104 and may power a variety of other machine systems, including various mechanical, electrical, and hydraulic systems and/or components. Further, the machine 100 may also include an operator control station 106, including a variety of operator controls and displays useful for operating the machine 100 and/or a dump body 108 which may be pivotal relative to the machine frame 102.

Different exemplary configurations of an engine and fuel system 200 of the machine 100 are shown in FIGS. 2 and 3, according to various embodiments of the present disclosure. Referring to FIG. 2, the engine and fuel system 200 includes an engine 202, a fuel storage tank 204 for providing fuel to the engine 202, and a fuel filtration system 206 for filtering the fuel supplied by the fuel storage tank 204. In an example, the engine 202 is an internal combustion engine. As can be seen in the accompanying figures, the engine 202, the fuel storage tank 204 and the fuel filtration system 206 are fluidly coupled such that the fuel filtration system 206 is provided downstream of the fuel storage tank 204.

The engine and fuel system 200 further comprises a fuel transfer pump 208 and one or more additional filters provided downstream of the fuel filtration system 206. The one or more additional filters are embodied as a secondary fuel filter 210 and a tertiary fuel filter 212 in the illustrated embodiments. Further, a high pressure pump 214 may be provided downstream of the secondary and tertiary fuel filters 210, 212. One of ordinary skill in the art will appreciate that the high pressure pump 214 is configured to pressurize the fuel flowing towards the engine 202. The direction of the fuel flow from the fuel storage tank 204 towards the engine 202, via the fuel filtration system 206, is shown by arrowheads in FIGS. 2 and 3.

As shown, the fuel filtration system 206 includes a pump 216, at least one filter 218 and a recirculation loop 219. The pump 216 may be a fixed displacement pump or a variable displacement pump. Also, the pump 216 may be a piezoelectric pump, an electric pump, a mechanical pump, a turbo-pump or any other pump known in the art. The pump 216 is fluidly connected to the fuel storage tank 204 in order to receive the fuel stored in the fuel storage tank 204.

The filter 218 may be positioned downstream of the fuel storage tank 204 and fluidly coupled to the pump 216. More specifically, in the exemplary embodiment shown in FIG. 2, the filter 218 is coupled to a pressure side of the pump 216. The recirculation loop 219 may be provided across the pump 216 and the filter 218 in such a manner to allow recirculation of at least a portion of the fuel back into the filter 218 for filtration in a subsequent pass. Further, a first check valve 220 may be disposed in the recirculation loop 219. Optionally, a second check valve 222 may be disposed in a bypass line 224 provided across the pump 216.

During operation, a flow of the fuel from the fuel storage tank 204 may be sucked or drawn into the pump 216, and then sent to the filter 218 which is present on the pressure side of the pump 216. The filter 218 is configured to remove unwanted debris, such as, for example, dust particles and metallic rust, present in the fuel. Thereafter, at least a portion of the flow of fuel exiting the filter 218 may be recirculated via the recirculation loop 219 to the suction side of the pump 216. This portion of fuel is then re-pumped from the pressure side of the pump 216 into the filter 218, in order to facilitate in the re-filtration of that portion of the fuel in the subsequent pass. It should be noted that such iterative filtering of the fuel may enhance the filtration functionality offered by the fuel filtration system 206.

Moreover, the portion of the fuel to be recirculated back to the filter 218 using the recirculation loop 44 may be determined based on a fuel consumption of the engine 202. In an example, the fuel consumption of the engine 202 is determined by a controller or electronic control unit (not shown) which may be communicably coupled to the engine 202. The fuel consumption of the engine 202 may be dependent on a variety of factors such as, for example, speed of the machine 100, geographical terrain on which the machine 100 is moving, payload on the machine 100, and the like. The fuel consumption of the engine 202 may vary in real time based on changes in these factors. Accordingly, the electronic control unit may dynamically determine the amount of fuel to be recirculated to the filter 218 based on the fuel consumption of the engine 202.

In an exemplary situation, in case there is failure of the pump 216, such that the pump 216 ceases to operate, the fuel from the fuel storage tank 204 may flow via the bypass line 224 towards the filter 218. The arrangement of the first check valve 220 provided in the recirculation loop 219 and the second check valve 222 provided within the bypass line 224 may prevent the fuel from flowing around the filter 218. Hence, an appropriate amount of the fuel may be recirculated back to the filter 218 via the bypass line 224. In one embodiment, the pump 206 may provide for priming of the fuel when the fuel filtration system 206 is under maintenance. A fluid may be used to create a needed pressure in the pump 216, such that a proper flow of the fuel may be regularized and/or maintained during clean-up of the fuel filtration system 206.

An alternative configuration of the fuel filtration system 206 is depicted in FIG. 3. In this configuration, the filter 218 is fluidly connected to the suction side of the pump 216. The fuel flow from the fuel storage tank 204 may be initially received by the filter 218. The filter 218 may remove the debris and impurities present in the fuel. Thereafter, the filtered fuel may be received by the pump 216. Further, the portion of the filtered fuel may be recirculated back to the filter 218 through the recirculation loop 219. The recirculated fuel may undergo further filtration in the subsequent pass through the filter 218.

Further, a remaining portion of the fuel, i.e., the portion of the fuel other than that which is sent for recirculation through the recirculation loop 219, may be received by the fuel transfer pump 208. It should be understood that the flow of the remaining portion of the fuel towards the fuel transfer pump 208 may occur simultaneously with the recirculation process. One of ordinary skill in the art will appreciate that the portion of the fuel to be recirculated may be substantially greater than the fuel consumption of the engine 202, in order to ensure that the engine 202 is always provided with the required amount of fuel.

The fuel transfer pump 208 may further pump the remaining portion of the fuel towards the secondary fuel filter 210 and the tertiary fuel filter 212. The remaining portion of the fuel may thus undergo further filtration in the secondary fuel filter 210 and the tertiary fuel filter 212 provided downstream of the fuel filtration system 206. It should be noted that the secondary fuel filter 210 and the tertiary fuel filter 212 may be substantially similar to the filter 218 in construction and composition. Although only two additional filters are depicted in the accompanying drawings, any number of such filters may be utilized.

The remaining portion of the fuel may then be received by the high pressure pump 214. It should be noted that the fuel may flow from the fuel storage tank 204 to the high pressure pump 214 at a low pressure level. The high pressure pump 214 may pressurize the fuel flow towards the engine 202. The fuel may then be utilized by the engine 202 for performing one or more operations of the machine 100. In one embodiment, a return line 226 connecting the engine 202 to the fuel storage tank 204, may allow unused fuel to flow back into the fuel storage tank 204.

### INDUSTRIAL APPLICABILITY

Debris present in the fuel may cause damage to the low and high pressure fuel systems associated with the engine of the machine. In some situations, the damage may be so severe as to cause the engine and/or the machine to become inoperable. The present disclosure relates to the fuel filtration system 206 which is configured to remove debris from the fuel and improve overall system durability with minimal changes to existing fuel and filtering systems present on standard machines.

The disclosed fuel filtration system 206 may extend the life of the engine and fuel system 200 and improve performance of the engine 202. Relatively clean fuel may be provided by the fuel filtration system 206 as soon as the fuel starts to flow in the system. Additionally, the design of the system is such that in case the pump 216 ceases to function, the fuel filtration system 206 may provide the filtered fuel in a conventional manner to the engine 202. Further, the fuel filtration system 206 may operate at low pressure and also provide priming functionality as explained earlier. The fuel filtration system 206 provides a compact and space effective solution.

At step 402, the flow of the fuel directed towards the pump 216 may be received from the fuel storage tank 204. The fuel may then be received by the fuel filtration system 206. At step 404, the fuel may be initially drawn through the filter 218 present upstream of the pump 216. In an alternate embodiment, the fuel may be received first through the pump 216, and then sent through the filter 218 which is coupled to the pressure side of the pump 216.

At step 406, the portion of the flow of the fuel may be recirculated through the filter 218 and the pump 216 via the recirculation loop 219. At step 408, the remaining portion of the fuel may be provided to the engine 202 during the recirculation. The quantity of the remaining portion of the fuel may be determined based on the fuel consumption of the engine 202.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A fuel filtration system comprising:
a pump configured to receive fuel from a fuel storage tank;
at least one filter positioned downstream of the fuel storage tank and fluidly coupled to the pump; and
a recirculation loop provided across the pump and the at least one filter, the recirculation loop configured to:
recirculate at least a portion of the fuel through the at least one filter; and
provide a remaining portion of the fuel to an engine during the recirculation, wherein the remaining portion of the fuel is determined based on a fuel consumption of the engine.

2. The fuel filtration system of claim 1, wherein the at least one filter is fluidly coupled to a suction side of the pump.

3. The fuel filtration system of claim 1, wherein the at least one filter is fluidly coupled to a pressure side of the pump.

4. The fuel filtration system of claim 1 further comprising a check valve provided in the recirculation loop.

5. The fuel filtration system of claim 1 further comprising a check valve provided across the pump.

6. The fuel filtration system of claim 1, wherein the pump includes any one of a fixed displacement pump and a variable displacement pump.

7. The fuel filtration system of claim 1 further comprising a high pressure pump provided downstream of the filtration system, wherein the remaining portion of the fuel is provided to the engine through the high pressure pump.

8. The fuel filtration system of claim 1 further comprising a fuel transfer pump in fluid communication with the filtration system.

9. The fuel filtration system of claim 1 further comprising one or more additional filters provided downstream of the filtration system.

10. A method comprising:
receiving a flow of fuel directed towards a pump from a fuel storage tank;
circulating the flow of fuel through at least one filter fluidly coupled to the pump;
recirculating at least a portion of the flow of fuel through the at least one filter; and
providing a remaining portion of the flow of fuel to an engine during the recirculation, wherein the remaining portion of the fuel is determined based on a fuel consumption of the engine.

11. The method of claim 10 further comprising receiving the flow of fuel through the pump, wherein the pump is positioned upstream of the filter.

12. The method of claim 10 further comprising drawing the flow of fuel through the filter, wherein the filter is positioned upstream of the pump.

13. A machine comprising:
an engine;
a high pressure pump fluidly coupled to the engine;
a fuel storage tank; and
a fuel filtration system fluidly coupled to the fuel storage tank, the fuel filtration system comprising:
a pump configured to receive fuel from the fuel storage tank;
at least one filter positioned downstream of the fuel storage tank and fluidly coupled to the pump; and
a recirculation loop provided across the pump and the at least one filter, the recirculation loop configured to:
recirculate at least a portion of the fuel through the at least one filter; and
provide a remaining portion of the fuel to the engine through the high pressure pump during the recirculation,
wherein the remaining portion of the fuel is determined based on a fuel consumption of the engine.

14. The machine of claim 13, wherein the at least one filter is fluidly coupled to a suction side of the pump.

15. The machine of claim 13, wherein the at least one filter is fluidly coupled to a pressure side of the pump.

16. The machine of claim 13 further comprising a check valve provided in the recirculation loop.

17. The machine of claim 13 further comprising a check valve provided across the pump.

18. The machine of claim 13, wherein the pump includes any one of a fixed displacement pump and a variable displacement pump.

19. The machine of claim 13 further comprising a fuel transfer pump in fluid communication with the filtration system.

20. The machine of claim 13 further comprising one or more additional filters downstream of the filtration system.
